(19) United States
(12) Patent Application Publication
(10) Pub. No.: US 2015/0169915 A1
(43) Pub. Date: Jun. 18, 2015

(54) ACTIVE RFID TAG WITH INTEGRATED ELECTRICAL PASS-THROUGH CONNECTION

(71) Applicant: THE CLEVELAND CLINIC FOUNDATION, Cleveland, OH (US)

(72) Inventors: Marc Petre, Shaker Hts., OH (US); David Matt, Aurora, OH (US)

(21) Appl. No.: 14/540,161

(22) Filed: Nov. 13, 2014

Related U.S. Application Data
(63) Continuation of application No. 14/530,940, filed on Nov. 3, 2014.
(60) Provisional application No. 61/916,427, filed on Dec. 16, 2013.
(60) Provisional application No. 61/974,503, filed on Apr. 3, 2014.

(51) Int. Cl. G06K 7/10

(52) U.S. Cl. CPC G06K 7/10366

(57) ABSTRACT

An active radio frequency identification (RFID) tag is provided that can include an input power connector, an output power connector and a wireless transceiver. The input power connector can be configured to receive an input electrical power signal from an external power source. The output power connector can be configured to supply an output electrical power signal to an external host device. The wireless transceiver can be configured to transmit or receive a location beacon signal.

### CROSS-REFERENCE TO RELATED APPLICATIONS

This application is a Continuation of U.S. patent application Ser. No. 14/530,940 filed Nov. 3, 2014 and entitled “ACTIVE RFID TAG WITH INTEGRATED ELECTRICAL PASS-THROUGH CONNECTION.” The entirety of the subject matter of this application is incorporated by reference herein. This application also claims the benefit of U.S. Provisional Patent Application No. 61/916,427 filed Dec. 16, 2013 and entitled “SYSTEM AND METHOD FOR POWER MANAGEMENT” and U.S. Provisional Patent Application No. 61/974,503 filed Apr. 3, 2014 and entitled “ALTERNATING CURRENT PASS-THROUGH ACTIVE RADIO FREQUENCY IDENTIFICATION DEVICES AND METHODS.” The entirety of the subject matter of these provisional applications is incorporated by reference herein.

### FIELD OF THE INVENTION

The present disclosure relates generally to active radio frequency identification (RFID) devices and, more specifically, to active RFID devices that support an integrated electrical pass-through connection between an electrical power source and an electrically powered host device.

### BACKGROUND OF THE INVENTION

Real-time location systems (RTLSs) are used to track the location of equipment and people, such as in manufacturing, warehousing, and healthcare applications. In an RTLS, small battery-powered tags (referred to herein as active radio-frequency identification (RFID) tags) with built-in wireless transmitters are attached to their associated host devices and programmed to periodically emit location beacon signals while wireless sensors at fixed, known positions monitor the incoming transmissions and triangulate on the tag positions to locate their associate host devices. In healthcare applications, one well-known downside with current tags is the need to replace or re-charge their batteries. Another is their inability to provide hospital staff with important contextual information, e.g., whether a medical device is plugged in, turned on, actively being used, or otherwise. It is inefficient to send a network administrator or other personnel to retrieve a piece of equipment only to find out that it is already being used, or to be unable to locate the equipment because its tag battery became depleted.

### SUMMARY OF THE INVENTION

The present disclosure relates generally to active radio frequency identification (RFID) devices and, more specifically, to active RFID devices (pass-through tags) that support an integrated electrical pass-through connection between an electrical power source and an electrically powered host device. Such pass-through tags can be placed between the input electrical power connector on a host device (e.g., an infusion pump or ventilator) and an electrical power cable for the host device. This placement of the pass-through tag can automatically recharge the tag's battery whenever the host device is plugged into an electrical outlet, essentially removing the need to replace or recharge the battery. The pass-through tag can also monitor the current consumption of the host device to measure its power consumption and to determine its usage state (e.g., not plugged in, plugged in and powered off, plugged in and actively being used, etc.).

According to an aspect of the present disclosure, an active radio frequency identification (RFID) tag is described. The active RFID tag can include an input power connector configured to receive an input electrical power signal from an external power source. The active RFID tag can also include an output power connector configured to supply an output electrical power signal to an external host device. The active RFID tag can also include a wireless transceiver configured to transmit or receive a location beacon signal.

According to another aspect of the present disclosure, a system is described. The system can include an input power connector that can be configured to receive an input electrical power signal from an external power source. The system can also include an output power connector configured to supply an output electrical power signal to an external host device. The system can also include a wireless transceiver configured to transmit or receive a location beacon signal.

According to a further aspect of the present disclosure, a method for displaying information about an active RFID tag is described. For example, the method can be performed by a device that includes a non-transitory memory and a processing resource (e.g., a mobile wireless device, a server, a computing device, etc.). The method can include receiving information contained in a wireless transmission from the tag, For example, the tag can include an input power connector configured to receive an input electrical power signal from an external power source, an output power connector configured to supply an output electrical power signal to the host device, and a wireless transceiver configured to transmit or receive a location beacon signal. The method can also include decoding from the information one or more of: a usage state of the tag, a current consumption measurement from the tag, a power consumption measurement from the tag, an identity of the tag, an identity of an external host device associated with the tag, a location of the tag or a location of the host device.

### BRIEF DESCRIPTION OF THE DRAWINGS

The foregoing and other features of the present disclosure will become apparent to those skilled in the art to which the present disclosure relates upon reading the following description with reference to the accompanying drawings.

FIG. 1 is a block diagram showing a system that can employ a pass-through tag between an electrical power source and an electrically powered host device (e.g., a medical equipment asset) in accordance with an example.

FIG. 2 is a block diagram showing an example of a pass-through tag that can monitor the power consumption of a host device in accordance with an example.

FIG. 3 is a block diagram showing an example of the pass-through tag that has a 3-wire alternating current (AC) pass-through connection and a cable connector (e.g., that can be utilized instead of a rigid connector) to interface with a host device in accordance with an example.

FIG. 4 is a flow chart depicting a method for converting an electrical current measurement to a usage state of a host device connected to a pass-through tag in accordance with an example.

FIG. 5 is a flow chart similar to FIG. 4, but showing the mapping from current measurement to usage state performed on a network server instead of inside the tag in accordance with an example.

FIG. 6 is a block diagram showing an example of a pass-through tag that can shut off the flow of power to the host device when a leakage current condition is detected in accordance with an example.

FIG. 7 is a block diagram depicting an example of the pass-through tag that can charge an internal battery from the pass-through connection in accordance with an example.

FIG. 8 is a block diagram showing a system that can that can display information related to the host device received from a pass-through tag in accordance with an aspect of the present disclosure in accordance with an example.

FIG. 9 is a block diagram showing a system in which information from one or more pass-through tags is sent to a server in accordance with an example.

FIG. 10 is a block diagram showing an exemplary system of hardware components capable of implementing portions of the systems and methods of the present disclosure.

FIG. 11 is a flow chart showing operations performed by a system in accordance with examples of the presented disclosure.

### DETAILED DESCRIPTION OF THE INVENTION

The present disclosure relates generally to an active radio frequency identification (RFID) device and, more specifically, to an active RFID device that supports an electrical pass-through connection between its associated host device and an electrical power source, and associated methods of use. In some instances, the pass-through connection can be used to monitor the power consumption of a host device. In other instances, the pass-through connection can be used to charge a battery of the RFID device.

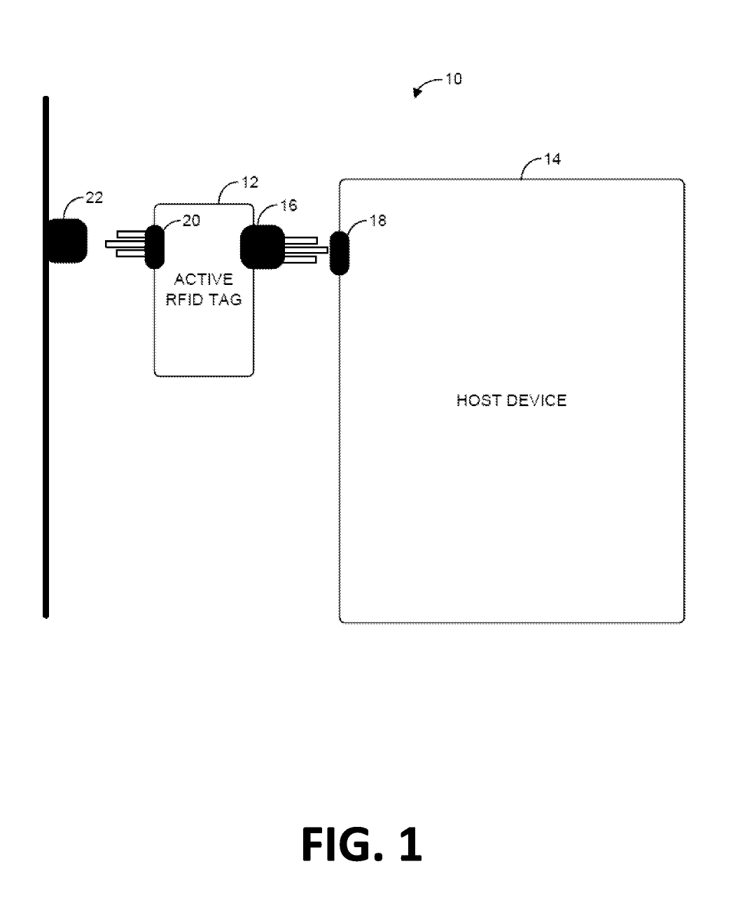

FIG. 1 illustrates an example of a system 10 employing an active RFID tag 12 that has an electrical pass-through connection between an external power source 22 and a host device 14. Active RFID tags are self-powered (e.g., via an internal battery) tags that can be attached to a host device, such as an infusion pump, ventilator or hospital bed, and transmit or receive location beacon signals that can be used to determine the location of the tag.

The active RFID device 12, also referred to herein as a “pass-through tag”, can interface with the external power source 22 through an input power connector 20 and with the host device 14 through an output power connector 16, where both input and output power connectors are positioned on the exterior of the RFID device. The input and output connectors are electrically connected using a “pass-through” connection inside the device 12.

The pass-through tag 12 can, through its output power connector 16, interface with a power input port 18 (e.g., an IEC 60320 C14 AC power inlet, barrel DC connector, USB connector, or other power input port) of the host device 14. Although the output power connector 16 is illustrated in FIG. 1 as a male connector and the power input port 18 is illustrated as a female connector, it will be appreciated that other types of connections and/or interfaces can exist between the output power connector 16 and the power input port 18. For example, the male and female components can be reversed (e.g., the power input port 18 can include a plug that can interface with the output power connector 16). In another example, a different type of output power connector 16 can be used that corresponds to the configuration of the power input port 18 (e.g., a USB connection and a USB port, a serial connection and a serial port, etc.).

The pass-through tag 12 can also, through its input power connector 20, interface with an external power source 22. The external power source 22 may be an AC power mains, line power source, an emergency generator, DC power supply or other power source external to the pass-through tag 12. Although the input power connector 20 is illustrated as a male connector and the external power source 22 is illustrated as a female connector, it will be appreciated that other types of connections and/or interfaces can exist between the input power connector 20 and the external power source 22. For example, the male and female components can be reversed (e.g., the external power source 22 can include a plug that can interface with the input power connector 20).

Thus, as depicted in FIG. 1, the output power connector 16 can supply an output electrical power signal based on the input electrical signal received by the input power connector 20. The input electrical power signal can include an alternating-current signal and the output electrical signal may comprise an alternating-current signal. In another form, the input electrical power signal can include a direct-current signal and the output electrical power signal comprises a direct-current signal.

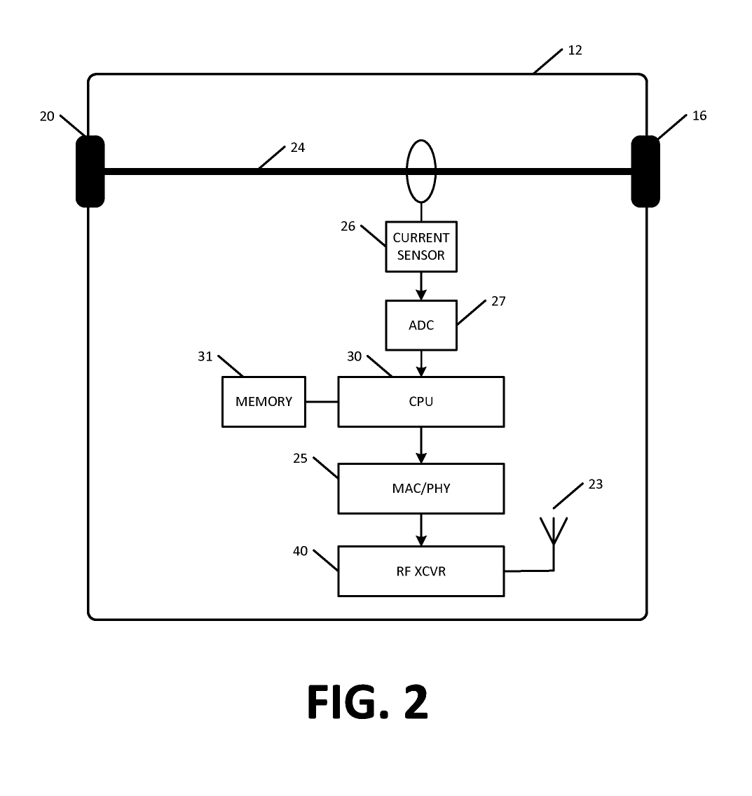

Turning now to FIG. 2, the pass-through tag 12 can contain a wireless media access control/physical layer (MAC/PHY) processor 25 and a RF transceiver (XCVR) 40. The RF transceiver 40 can send and receive RF signals through an antenna 23 that can be positioned either inside our outside the tag 12. The MAC/PHY processor 25 and RF transceiver 40 can be used to exchange wireless location information with one or more wireless networking devices to allow the network to identify and track the location of the tag 12 and/or its associated host device 14. The MAC/PHY processor 25 and RF transceiver 40 could operate in accordance with a wireless standard such as IEEE 802.11/Wi-Fi®, Bluetooth®, Bluetooth Low Energy or IEEE 802.15.4 Zigbee to communicate with the wireless networking devices. In addition, the tag 12 may include a current sensor 26, and analog-to-digital converter 27, and a central processing unit (CPU)/processor 30 with an associated memory 31 for storing executable instructions and data. It is to be understood that the memory 31 is present in the various examples of the tag 12 presented herein, but for simplicity, it is not shown again the subsequent figures. The CPU/processor 30 is configured to execute the executable instructions to, among other things, determine a usage state of the host device using the measurement obtained by the current sensor 26. The CPU/processor 30 may encode the measurement obtained by the current sensor 26 into a data packet for transmission by the wireless transceiver 40.

The memory 31 can include read only memory (ROM), random access memory (RAM), magnetic disk storage media devices, optical storage media devices, flash memory devices, electrical, optical, or other physical/tangible/non-transitory memory storage devices. Thus, in general, the memory 31 may comprise one or more tangible (non-transitory) computer readable storage media (e.g., a memory device) encoded with software comprising computer executable instructions and when the software is executed (by the controller CPU 30) it is operable to perform various operations described herein.

In one example, the pass-through tag 12 can emit location beacon signals that are received by one or more wireless networking devices and used by the wireless networking devices to track the location of the tag 12. In other examples, the pass-through tag 12 can receive location beacon signals sent from wireless networking devices and use the received signals to determine its own location. In these cases, after determining its own location the tag may transmit, using one or more data packets, its location to one or more of the wireless networking devices. These data packets may also contain information such as a MAC address that the networking devices can use to identify the tag 12 and or the host device 14.

In addition to providing identity and location information, the wireless signals sent from the pass-through tag 12 to the one or more wireless networking devices can contain current consumption measurements, battery state-of-charge information, or the detected usage state of the host device. These signals could also contain alert information such as a low-battery, excessive leakage current or GFI (ground fault interruption) alert and the like. As shown in FIG. 2, the current sensor 26 can monitor the electrical current or power being consumed by the host device on the pass-through connection 24. Any one of a number of well-known current sensing techniques can be used to measure the pass-through current, including: (1) a wire loop or inductor surrounding the current-carrying terminals, in which case the voltage between the loop or inductor input and output terminals would be proportional to the current flowing through the loop, (2) a hall-effect sensor or (3) a voltage comparator measuring the voltage drop a cross a reference resistor. The current sensor 26 provides a measurement of the electrical current being consumed by the host device 14 through the output power connector 16. The analog-to-digital converter (ADC) 27 may be provided to periodically sample, digitize and scale the current sensor output into an instantaneous current or power reading. The output of the ADC 27 can be lowpass filtered or averaged by the CPU 30 to convert the instantaneous current or power readings into RMS averages.

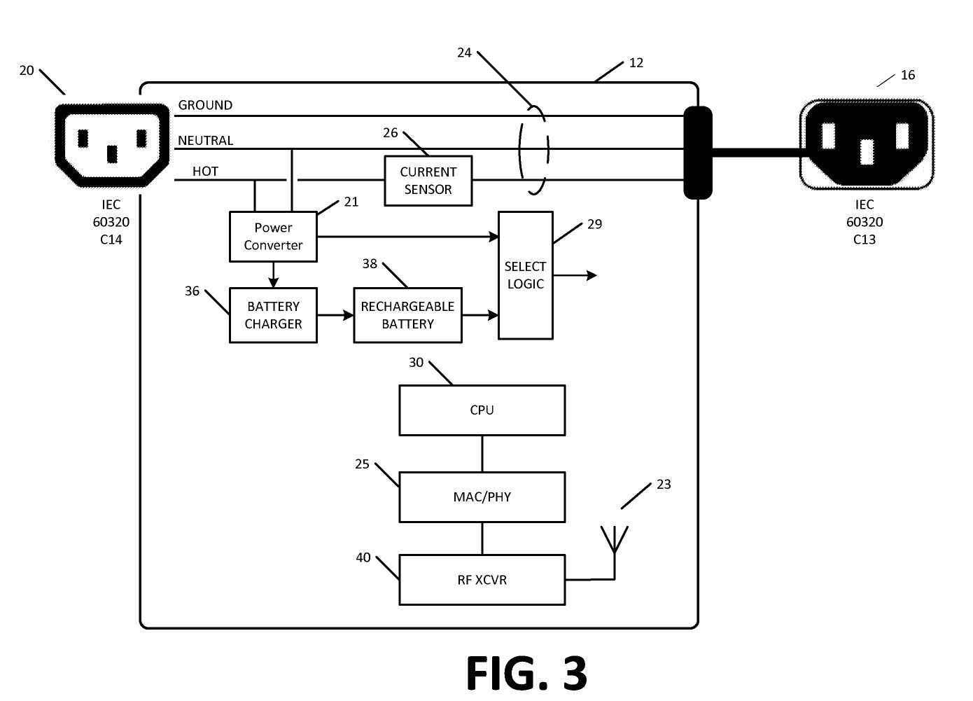

The pass-through connection 24 is illustrated in FIG. 2 as a single line or wire. However, it will be appreciated that the connection 24 can include a plurality of lines or wires. In this regard, reference is now made to FIG. 3. In one example, as illustrated in FIG. 3, when an IEC 60320 C14 inlet connector is used as the input power connector 20 and a 3-terminal AC power cable terminated with an IEC 60320 C13 is used as the output power connector 16, the pass-through connection 24 could be a direct electrical connection between all 3 signals (hot, neutral and ground).

In some cases, a cable connector rather than a rigid connector may be used as the output power connector 16. It is also possible to use a cable instead of a rigid connector for the input power connector 20. For example, in the United States, a 3-terminal power cable terminated by a NEMA 5-15p to interface with an AC mains could be used as the input power connector 20 instead of a rigid connector such as a IEC 60320 C14. Thus, one or more of the input power connector and output power connector may include a cable.

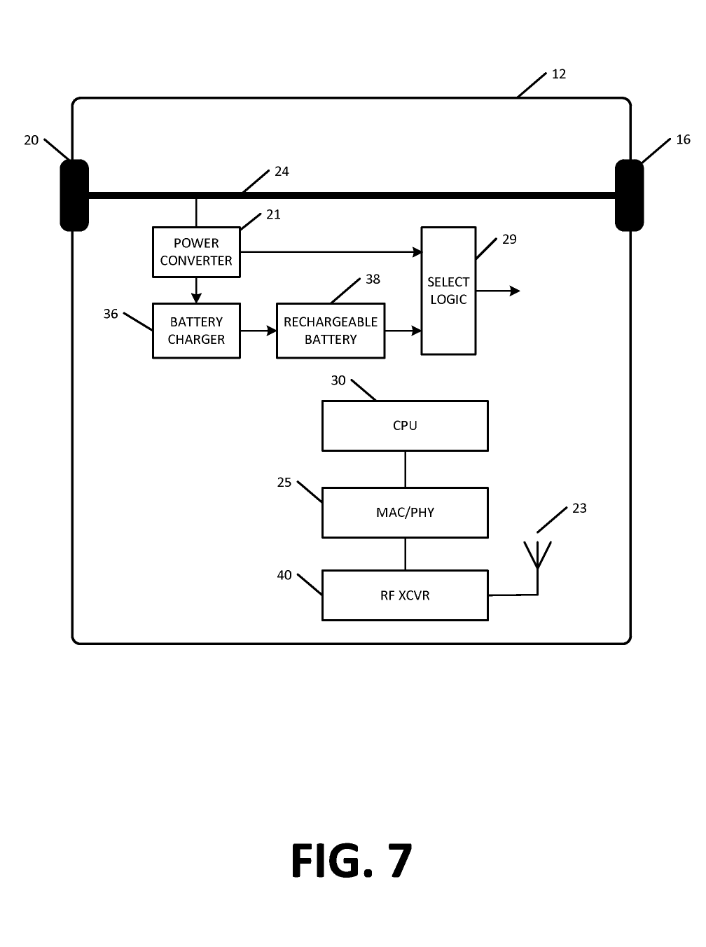

FIG. 3 also shows that there is an AC/DC and DC/DC converter 21 connected to the hot and neutral lines, a battery charger 36 connected to the power converter 21, a rechargeable battery 38 connected to the battery charger 36 and selection logic 29 connected to the rechargeable battery 39 and AC/DC and DC/DC converter 21. The operation of these components is described below in connection with FIG. 7.

The output of the current sensor 26 can be used to determine the usage state of the host device. This is because a host device generally consumes a different amount of electrical current in each of its usage states. For example, a medical device such as an infusion pump will consume zero electrical current from its AC input power port when it is unplugged from an AC power source. The medical device will consume a small amount of AC current when plugged into the AC power source but powered off; more current when it is plugged in, powered on and idle; and even more current when plugged in, powered on and actively being used. Each host device generally consumes a measurably different amount of current in each of its usage states (e.g., actively administering a medication, idle waiting to be programmed, diagnostics mode, etc.), and there is usually a one-to-one correspondence between the amount of current being consumed and its usage state. The mapping of current consumption to usage state generally varies as a function of device type, manufacturer and model number. This mapping information could be measured for each unique combination of device type, manufacturer and model number and stored in a database. A pass-through tag could look up the mapping information for its associated host device from such a database, store it internally in a non-volatile memory, and use this information along with current consumption measurements to determine the usage state of the host device.

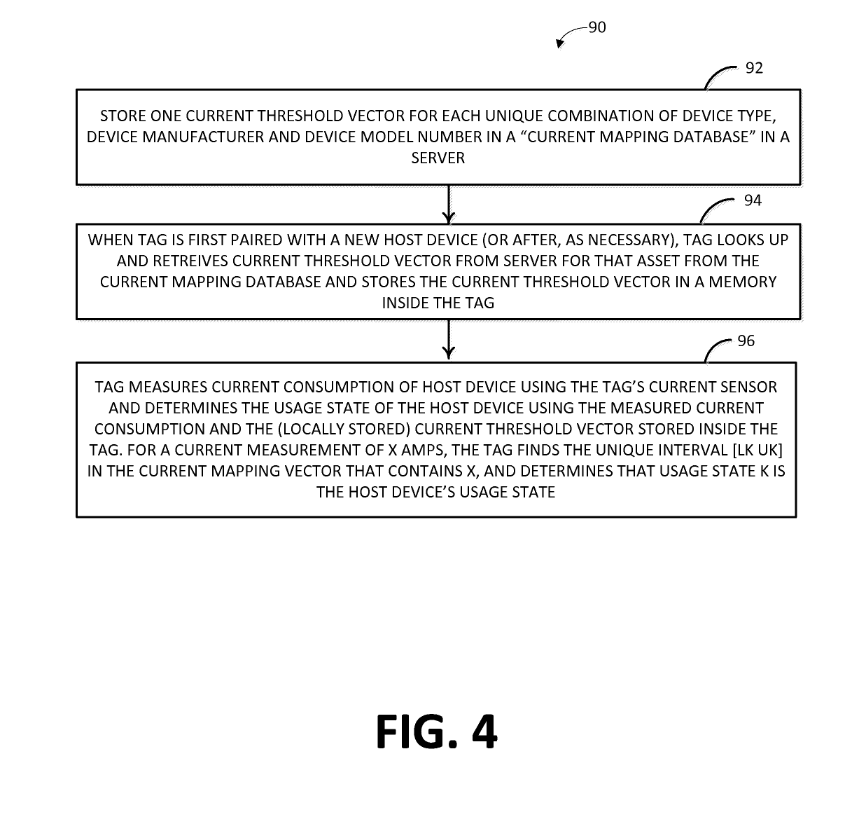

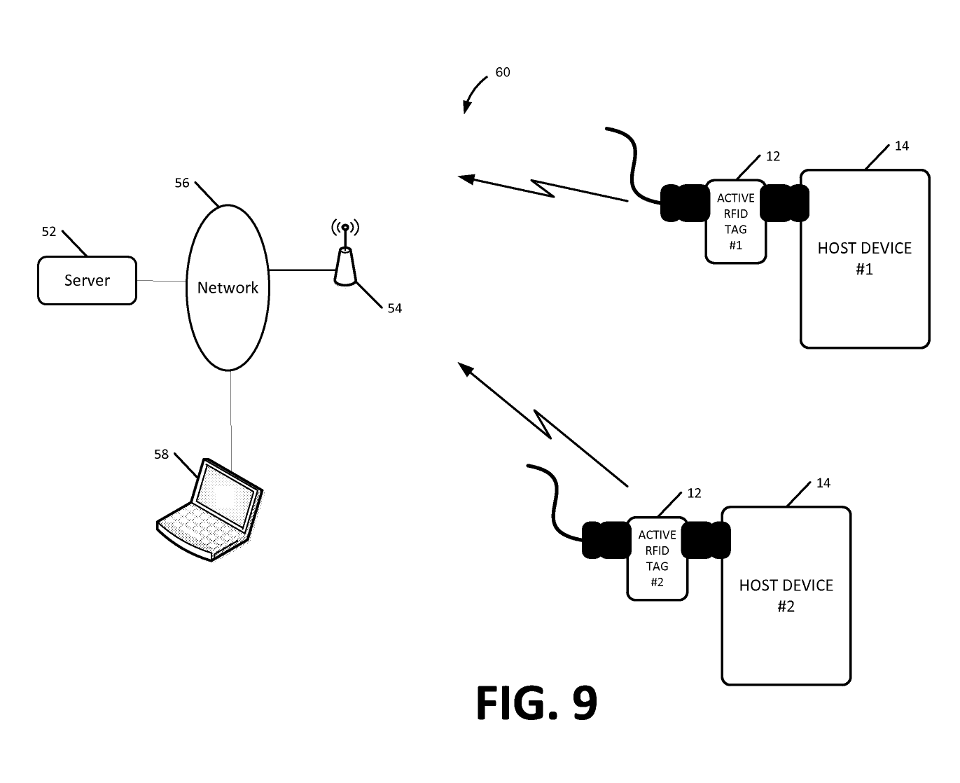

FIG. 4 depicts operations for such a procedure 90 in more detail. In step 92 of the procedure 90, a current threshold vector is loaded into a current mapping database of a server for each unique combination of device type (e.g., infusion pump, ventilator, etc.), device manufacturer (e.g., Philips, GE) and model number for the host device. An example of a server is shown in FIG. 9. Thus, step 92 can be performed by instructions stored in a non-transitory memory and executed by a processor of a server. The current threshold vector associated with a particular host device can be defined as a vector [L₁ U₁ . . . L_{N} U_{N}], where Lₖ and Uₖ are lower and upper thresholds used to determine when a host device is in operating state k and N is the number of operating states for that device. The host device is determined to be in state k when its measured RMS current consumption, in amps, is between thresholds Lₖ and Uₖ. The lower and upper thresholds in the current consumption vector for each device can be selected so that no two intervals overlap to ensure a unique mapping from measured current consumption to detected usage state.

In step 94 of procedure 90, when the tag is first paired with a host device (or after initial pairing, as necessary), the tag sends a message to the server which in turn looks up and retrieves the current threshold vector for that host device in the current mapping database and sends data for that current threshold vector to the tag. The tag stores the data for the current threshold vector in a memory (e.g., memory 31) inside the tag. In step 96 of procedure 90, after the current threshold vector is stored in its internal memory, whenever the tag measures the current consumption of the host device it can map that measurement to an associated usage state by finding the (unique) interval [Lₖ, Uₖ] containing the measured current consumption for some integer k and determining that usage state k is the usage state. Thus, steps 94 and 96 can be performed by instructions stored in a memory of a tag, which instructions are executed by a process (e.g., CPU 30) of the tag.

The same usage state detection procedure can be performed in a network server instead of in the tag. In this case, the pass-through tag would periodically broadcast its current consumption measurements on a wireless network while a network server device (possibly also containing the current mapping database) receives the incoming broadcasts. The network server would then map the current consumption measurements it receives from the tag to detected usage states for the host device using the received current measurements and the mapping information for that host device type.

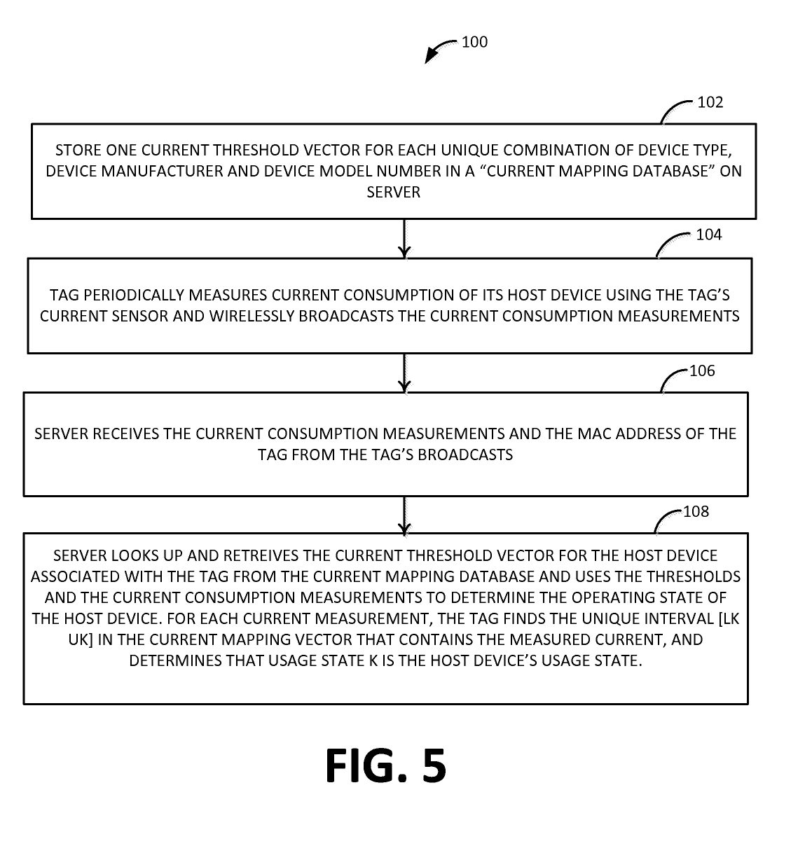

FIG. 5 depicts operations for a procedure 100. Step 102 of the procedure 100 is identical to Step 92 of FIG. 4. In step 104 of procedure 100, the tag periodically measures the current consumption of its host device and wirelessly broadcasts the current measurements. These broadcasted measurements are received by one or more wireless network devices (e.g., wireless access points) which are in turn communicated to the server. Such a system arrangement is shown in FIG. 9, described hereinafter. In step 106 of procedure 100, the server receives the broadcasts and decodes the current consumption measurements and the MAC address of the tag. In step 108 of procedure 100, the server looks up the current threshold vector for the host device associated with the tag's MAC address from a current mapping database, and maps one or more of the decoded current consumption measurements to an associated usage state by finding the (unique) interval [Lₖ, Uₖ] containing the measured current consumption for some integer k, and determining that usage state k is the usage state. Thus, one or more of the operations of procedure 100 can be performed by instructions stored in a non-transitory memory and executed by a processor of a server.

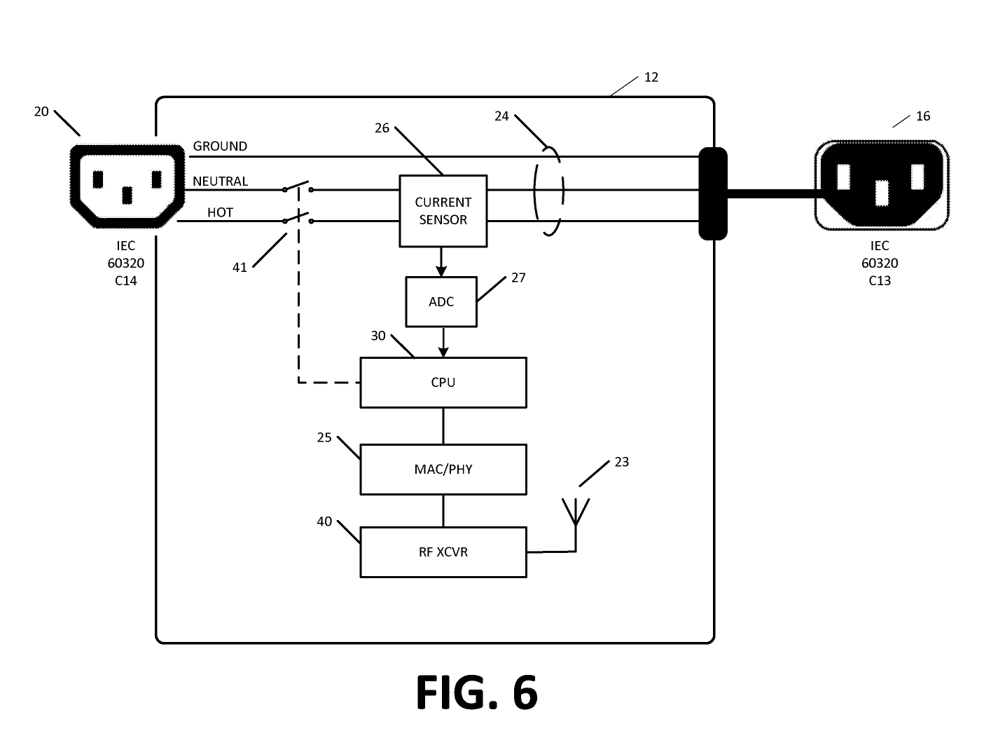

The pass-through tag 12 can include a switch that can be used to cut off the flow of electrical power to the host device 14—either to conserve power when directed by the network via an incoming wireless message, or as a safety measure when a or ground fault interruption (GFI) or leakage current condition occurs. Excessive leakage current can indicate that the host device 14 may be malfunctioning and/or unsafe. For example, a malfunctioning and/or unsafe host device can electrically shock a human (e.g., a patient, a doctor, a nurse, an aide, or the like) who completes a circuit with the host device. Referring now to FIG. 6, in an AC-powered system, leakage current is the differential flow of current in the hot line relative to the neutral line. The current sensor 26 can measure leakage current by enclosing both lines with a wire loop or coil and digitizing the voltage between the loop or coil terminals using an ADC 27. Another technique would be to subtract the two signals (e.g., using a center-tap transformer) and measure their differential current using a hall-effect sensor before the ADC 27. Thus, the current sensor 26 can be configured to determine a differential flow of current to the host device on a hot terminal relative to a neutral terminal in the output power connector in order to provide a measure of leakage current.

The CPU 30 can periodically monitor the leakage current and open the switch 41 to cut off the current when it exceeds an appropriate threshold. The switch 41 may have multiple relays, in one example. As an example, the alert can be generated when the leakage current is greater than or equal to a threshold value of 4 mA-6 mA. For different types of host devices, the alert can be generated when the leakage current is greater than or equal to different threshold values defined by respective standards and/or regulations for the industry or the application of the host device 14. For medical equipment, an example of a standard is IEC 60601-1 standard, “Medical Electrical Equipment—Part 1: General Requirements for Safety and Essential Performance.” In addition to opening the relays of switch 41 to shut off the flow of current, the tag 12 may also send a wireless alert message (e.g., as a Wi-Fi packet) to notify the network that the leakage condition was detected.

Thus, FIG. 6 illustrates switch 41 configured to enable or disable the flow of the electrical power to the output power connector, and CPU/processor 30 that configures the switch 41 to disable the flow of electrical power to the output power connector when the differential flow of current indicates a malfunction of the host device 14.

Referring now to FIG. 7, when the pass-through tag 12 is connected to an external power source 22, instead of (or in addition to) measuring the host device's current consumption, the pass-through tag 12 can charge a rechargeable battery 38 with a battery charger circuit 36 using the pass-through signal 24. The rechargeable battery 38 can then be used to power the RFID device when it is disconnected from the power source 22. Selection logic 29 can be deployed in the tag 12 to power its electronics from the pass-through power signal 24 when the tag is plugged in to the power source 22, or from the rechargeable battery 38 when unplugged. The power converter 21 can be either an AC-to-DC converter, a regulated DC-to-DC converter or voltage divider, depending on the nature of the application. The output from the power converter 21 can be fed both to the selection logic 29 and the battery charger 36. The selection logic 29 may take the form of a relay or a switch that can be configured to select the battery 38 as the power source when there is no power signal present at the input to the power converter 21, or the power converter output 21 when a power signal is present at the input to the power converter 21. The selection logic 29 may take the form of a dedicated integrated circuit or software instructions executed by the CPU 30.

Thus, FIG. 7 shows that the tag 12 may further include a rechargeable battery and a battery recharge circuit. The battery recharge circuit is configured to charge the rechargeable battery using the input electrical power signal, and the rechargeable battery is configured to supply electrical power to the tag when the tag is unplugged from its external power source.

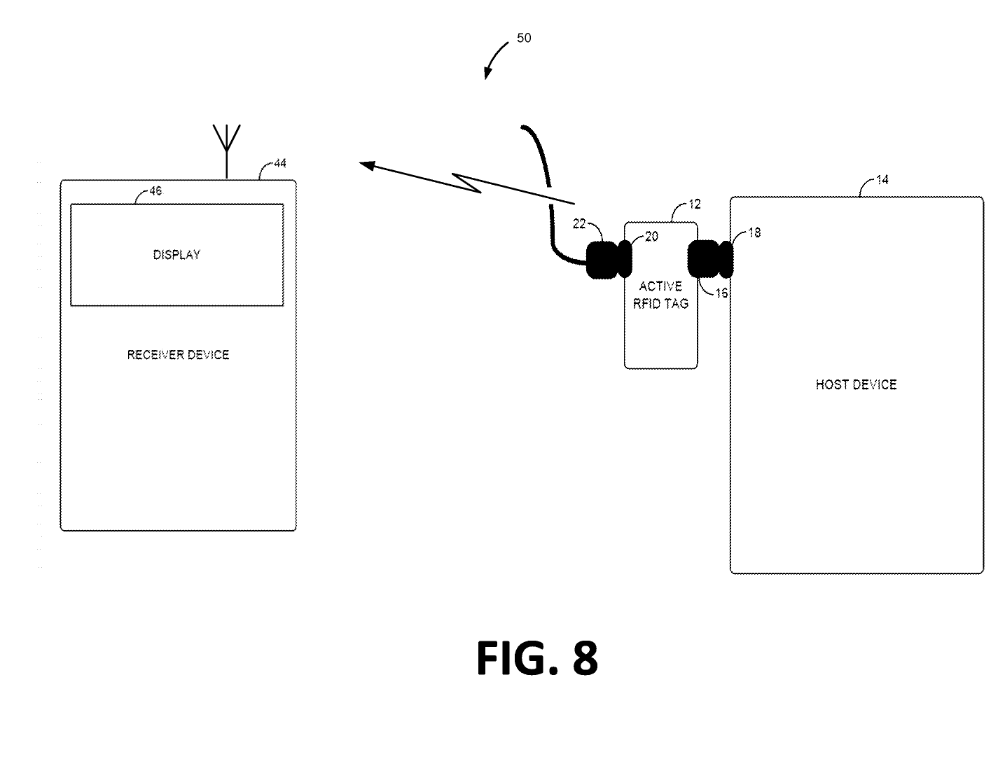

The pass-through tag 12 can communicate with a receiver device 44 as schematically shown in FIG. 8. The communication can be a wireless signal (e.g., one or more Wi-Fi or Bluetooth Low Energy packets) that can contain information related to one or more of: the measured instantaneous or RMS current or power consumption of the host device 14, location beacon signals, alert signals, and the usage state of the host device 14. The receiver device 44 can display information related to the host device 14 (e.g., received signal strength, estimated distance to receiver, usage state history, current consumption history, current consumption statistics, usage state statistics, alerts, etc.) on a display 46 (e.g., an LCD screen, or the like).

FIG. 9 shows a system 60 in which one or more pass-through tags 12 affixed to host devices 14 can send wireless signals to a server 52 through a wireless networking device 54 (e.g., a Wi-Fi access point). The server 52 and the wireless networking device 54 are connected to a network 56 that may include local area networks, and wide area networks (e.g., the Internet). The wireless signals can contain information related to one or more of: the measured instantaneous or RMS current or power consumption of the host devices 14, location beacon signals, alert signals, and the usage states of the host devices 14. The server 52 can store this information in a database, and make it available for one or more network terminals/endpoints 58 (e.g., laptops, smartphones, tablet PCs), to display to a user (e.g., usage state history for one or a group of host devices, current consumption history for one or a group of host devices, current consumption statistics, usage state statistics, alerts, etc.). Moreover, the server 52 may perform the operations described above in connection with FIG. 5. The server 52 may be a stand-alone server that has network connectivity, be part of a server farm, or it may be a server application running in a data center/cloud computing environment (i.e., “in the cloud”).

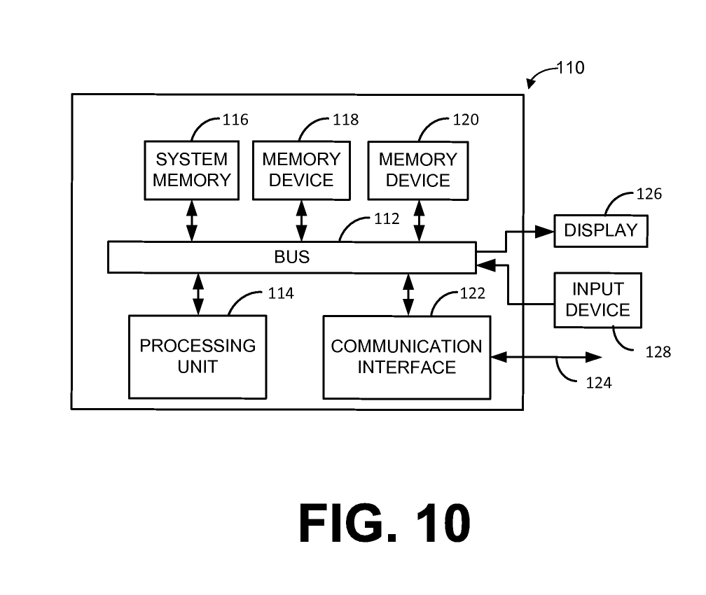

Reference is now made to FIG. 10. FIG. 10 is a schematic block diagram illustrating an example of a system 110 of hardware components capable of implementing at least a portion of the systems and methods of the present disclosure. The system 110 can include various systems and subsystems, including a personal computer, a laptop computer, a workstation, a computer system, an appliance, an application-specific integrated circuit (ASIC), a server (e.g., server 52 depicted in FIG. 9), a server blade center, a server farm, etc.

The system 110 can includes a system bus 112, a processing unit 114, a system memory 116, additional memory devices 118 and 120, a communication interface 122 (e.g., a network interface), a communication link 124, a display 126 (e.g., a video screen), and an input device 128 (e.g., a keyboard and/or a mouse). The system bus 112 can be in communication with the processing unit 114 and the system memory 116. The additional memory devices 118 and 120, such as a hard disk drive, server, stand alone database, or other non-volatile memory, can also be in communication with the system bus 112. The system bus 112 interconnects the processing unit 114, the memory devices 116, 118, 120, the communication interface 122, the display 126, and the input device 128. In some examples, the system bus 112 also interconnects an additional port (not shown), such as a universal serial bus (USB) port. The processing unit 114 can be a computing device that executes a set of instructions to implement the operations of examples disclosed herein. The processing unit 114 can include a processing core.

The memory devices 116, 118, 120 can store data, programs, instructions, database queries in text or compiled form, and any other information that can be needed to operate a computer. The memory devices 116, 118, 120 can be implemented as tangible computer-readable media (integrated or removable) such as a memory card, disk drive, compact disk (CD), or server accessible over a network. In some examples, the memory devices 116, 118,120 can be include text, images, video, and/or audio, portions of which can be available in formats comprehensible to human beings. Additionally or alternatively, the system 110 can access an external data source or query source through the communication interface 122, which can communicate with the system bus 112 and the communication link 124.

In operation, the system 110 can be used, for example, to implement one or more parts of a receiver device 44 shown in FIG. 8, that can display information related to a host device 14 received from an active RFID device 12 in accordance with the present invention. Computer executable logic for implementing the functionality of the receiver device 44 can reside on one or more of the system memory 116, and the additional memory devices 118, 120 in accordance with certain examples. The processing unit 114 can execute one or more computer executable instructions originating from the system memory 116 and the additional memory devices 118 and 120. The term “computer readable medium” as used herein refers to a medium that participates in providing instructions to the processing unit 114 for execution, and can, in practice, refer to multiple, operatively connected apparatuses for storing machine executable instructions.

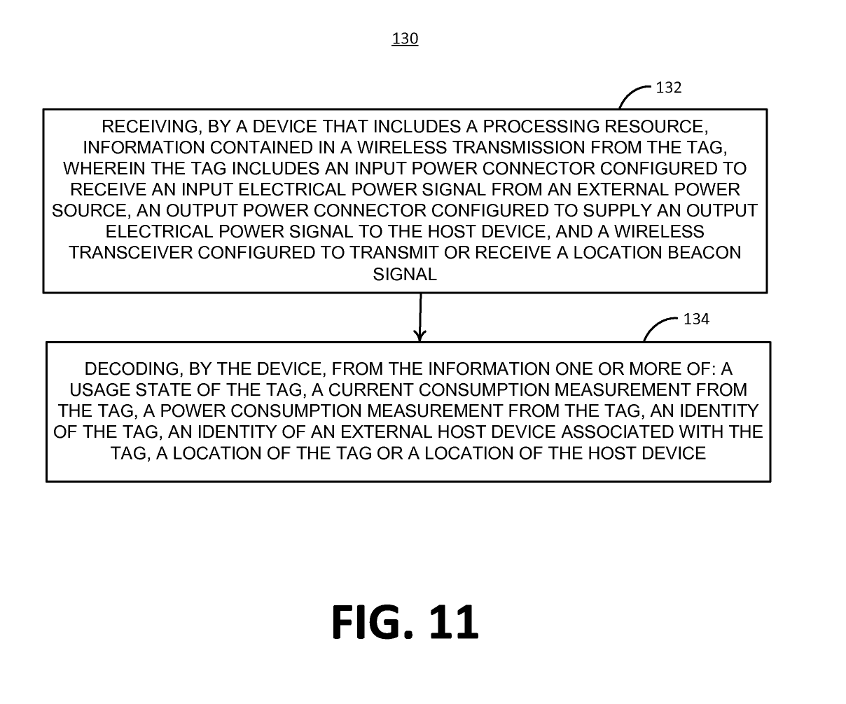

FIG. 11 illustrates a flowchart for a process 130 that may be performed in part by the system 110 shown in FIG. 10 and in part by the active RFID tag as described in various forms in this disclosure. The process 130 is useful to display information about an active RFID tag. At 132, information is received by a device that includes a processing resource, the information contained in a wireless transmission from the tag, wherein the tag includes an input power connector configured to receive an input electrical power signal from an external power source, an output power connector configured to supply an output electrical power signal to the host device, and a wireless transceiver configured to transmit or receive a location beacon signal. At 134, the information is decoded by the device to obtain one or more of: a usage state of the tag, a current consumption measurement from the tag, a power consumption measurement from the tag, an identity of the tag, an identity of an external host device associated with the tag, a location of the tag or a location of the host device. The receiving and decoding, along with displaying of the information, may be performed by a single mobile wireless device having a receiver and a display screen as shown in FIG. 8. In another form, the receiving and decoding are performed by a server, and the server sends the information to one or more network terminals, as shown in FIGS. 9 and 10.

From the above description, those skilled in the art will perceive improvements, changes and modifications. Such improvements, changes and modifications are within the skill of one in the art and are intended to be covered by the appended claims.

1. An active radio frequency identification (RFID) tag, comprising:
an input power connector configured to receive an input electrical power signal from an external power source;
an output power connector configured to supply an output electrical power signal to an external host device, the output power connector being electrically connected to the input power connector; and
a wireless transceiver configured to transmit or receive a location beacon signal, wherein the wireless transceiver is electrically powered via the input electrical power signal.

2. (canceled)

3. The active RFID tag of claim 1, wherein the output electrical power signal is based on the input electrical power signal.

4. The active RFID tag of claim 1, wherein the input electrical power signal comprises an alternating-current signal and the output electrical power signal comprises an alternating-current signal.

5. The active RFID tag of claim 1, further comprising a current sensor configured to provide a measurement of the electrical current being consumed by the host device through the output power connector.

6. The active RFID tag of claim 5, further comprising:
a processor configured to determine a usage state of the host device using the measurement.

7. The active RFID tag of claim 5, further comprising a processor configured to encode the measurement into a data packet for transmission by the wireless transceiver.

8. The active RFID tag of claim 1, further comprising a current sensor configured to determine a differential flow of current to the host device on a hot terminal relative to a neutral terminal in the output power connector in order to provide a measure of leakage current.

9. The active RFID tag of claim 8, further comprising:
a switch configured to enable or disable the flow of the electrical power to the output power connector; and
a processor that configures the switch to disable the flow of electrical power to the output power connector when the differential flow of current indicates a malfunction of the host device.

10. The active RFID tag of claim 1, further comprising a rechargeable battery and a battery recharge circuit, wherein the battery recharge circuit is configured to charge the rechargeable battery using the input electrical power signal, and wherein the rechargeable battery is configured to supply electrical power to the active RFID tag when the tag is unplugged from its external power source.

11. The active RFID tag of claim 1, wherein one or more of the input power connector and output power connector is a cable.

12. A system, comprising:
an active radio frequency identification (RFID) device, comprising:
an input power connector configured to receive an input electrical power signal from an external power source;
an output power connector configured to supply an output electrical power signal to an external host device, the output power connector being electrically connected to the input power connector; and
a wireless transceiver configured to transmit or receive a location beacon signal, wherein the wireless transceiver is electrically powered via the input electrical power signal.

13. The system of claim 12, further comprising a current sensor configured to provide a measurement of the electrical current being consumed by the host device through the output power connector.

14. The system of claim 13, further comprising:
a processor configured to determine a usage state of the host device using the measurement.

15. The system of claim 12, further comprising a rechargeable battery and a battery recharge circuit, wherein the battery recharge circuit is configured to charge the rechargeable battery using the input electrical power signal, and wherein the rechargeable battery is configured to supply electrical power to the system when it is disconnected from the external power source.

16. The system of claim 12, further comprising a current sensor configured to determine a differential flow of current to the host device on a hot terminal relative to a neutral terminal in the output power connector in order to provide a measure of leakage current.

17. A method for displaying information about an active radio frequency identification (RFID) tag, comprising:
receiving, by a device that includes a processing resource, information contained in a wireless transmission from the tag, wherein the tag includes an input power connector configured to receive an input electrical power signal from an external power source, an output power connector configured to supply an output electrical power signal to the host device, wherein the input power connector is electrically connected to the output power connector, and a wireless transceiver configured to transmit or receive a location beacon signal, wherein the wireless transceiver is electrically powered via the input electrical power signal; and
decoding, by the device, from the information one or more of: a usage state of the tag, a current consumption measurement from the tag, a power consumption measurement from the tag, an identity of the tag, an identity of an external host device associated with the tag, a location of the tag or a location of the host device.

18. The method of claim 17, further comprising displaying the information on a display screen of the device, and wherein the device comprises a single mobile wireless device having a wireless receiver and the display screen.

19. The method of claim 17, wherein the device comprises a server.

20. The method of claim 19, further comprising storing the information received from tag at the server, and sending the information from the server to one or more network terminals.
